(19) United States
(12) Patent Application Publication
(10) Pub. No.: US 2015/0107745 A1
(43) Pub. Date: Apr. 23, 2015

(54) Pneumatic Radial Tire for Use on Passenger Car

(71) Applicant: The Yokohama Rubber Co., LTD., Minato-ku, Tokyo (JP)

(72) Inventor: Shinya Harikae, Hiratsuka-shi, Kanagawa (JP)

(21) Appl. No.: 14/403,568

(22) PCT Filed: May 20, 2013
(86) PCT No.: PCT/JP2013/063940

§ 371 Date: Nov. 24, 2014

(30) Foreign Application Priority Data
May 24, 2012 (JP) 2012-118516

(51) Int. Cl. B60C 9/20; B60C 9/28

(52) U.S. Cl. CPC B60C 9/20; B60C 9/28; B60C 2009/2012
USPC 152/535

(57) ABSTRACT

A pneumatic radial tire for use on a passenger car of the present technology includes a main belt layer in which belt plies with steel cords embedded at an angle of 15° to 45° with respect to a tire circumferential direction are overlapped in two layers in mutually crossing directions on an outer side in a tire radial direction of a carcass layer of a crown region, wherein, as a belt auxiliary layer, plies with steel cords embedded at an angle of 80° to 90° with respect to a tire circumferential direction are disposed between a carcass layer and an inner side main belt layer so that a portion of the plies is in a position separated 30 mm to the tire equator side, respectively, from both ends in a width direction of the narrow width main belt layer.

### TECHNICAL FIELD

The present technology relates to a pneumatic radial tire for use on a passenger car.

More specifically, the present technology relates to a pneumatic radial tire for use on a passenger car that can retain a high degree of durability without reduction and can remarkably reduce rolling resistance to thereby improve fuel efficiency and have an excellent effect on reducing environmental impact.

### BACKGROUND

Generally, pneumatic radial tires for use on passenger cars have a structure in which a carcass layer, including carcass cords oriented in a tire radial direction, is mounted between a pair of bead portions and a belt layer, including a plurality of steel cords inclined with respect to a tire circumferential direction, is disposed on an outer circumferential side of the carcass layer in a tread portion.

In recent years, societal demands for resource conservation and energy conservation, namely environmental impact reductions, have also been demanded for improved fuel efficiency in automobile tires, and in response to this, a pneumatic radial tire for a passenger car with reduced rolling resistance has been desired.

An example of a method to reduce rolling resistance is to reduce the weight of the tire. For example, a reassessment of the configuration of belt cords used in the belt layer is being conducted in an effort to reduce these.

For example, it has been proposed that instead of a stranded wire cord where a plurality of filaments is twisted together, a monofilament steel wire is used as a belt cord to make a plurality of pairs of two-strand steel wires molded in a spiral shape and used as a specified spiral diameter, spiral pitch, monofilament wire diameter, and the like to thin the belt layer, lighten the tire, reduce rolling resistance, and thereby improve fuel efficiency (see Japanese Unexamined Patent Application Publication No. H08-300905).

However, reducing the belt cord in this manner leads to a new problem of reducing durability. With that as proposed above, the monofilament steel wire has extremely poor fatigue resistance with respect to flexing, and as such, has low so-called belt breakage durability.

### SUMMARY

The present technology provides a pneumatic radial tire for use on a passenger car that can retain a high degree of durability in the tire even when belt cords are reduced to achieve reduced rolling resistance.

A pneumatic radial tire for use on a passenger car of the present technology that achieves the aforementioned object is configured from a configuration (1) below.

(1) A pneumatic radial tire for use on a passenger car includes a main belt layer in which belt plies with steel cords embedded at an angle of 15° to 45° with respect to a tire circumferential direction are overlapped in two layers in mutually crossing directions on an outer side in a tire radial direction of a carcass layer of a crown region, wherein, as a belt auxiliary layer, plies with steel cords embedded at an angle of 80° to 90° with respect to a tire circumferential direction are disposed between a carcass layer and an inner side main belt layer so that a portion of the plies is in a position separated 30 mm to the tire equator side, respectively, from both ends in a width direction of a narrow width main belt layer, and the belt auxiliary layer has a width of not less than 30 mm and an initial stiffness value of not more than an initial stiffness value of the main belt layer.

Further, the pneumatic radial tire for use on a passenger car of the present technology, preferably, is configured from a configuration of any one of the following (2) to (8).

(2) The pneumatic radial tire for use on a passenger car according to (1) above, wherein the belt auxiliary layer has an initial stiffness value of not less than 0.5 times and not more than 0.97 times an initial stiffness value of the main belt layer.

(3) The pneumatic radial tire for use on a passenger car according to (1) or (2) above, wherein the steel cord constituting the main belt layer is a steel monofilament.

(4) The pneumatic radial tire for use on a passenger car according to (3) above, wherein the steel cord constituting the main belt is disposed in a belt layer as a bundled wire formed from a set of two to five steel monofilaments.

(5) The pneumatic radial tire for use on a passenger car according to (1) or (2) above, wherein the steel cord constituting the belt auxiliary reinforcing layer is a steel cord in which two or more steel wires are twisted together.

(6) The pneumatic radial tire for use on a passenger car according to any one of (1) to (5) above, wherein the product of a cross-sectional area of a steel cord constituting the main belt and a thread count per 50 mm unit width is not less than 4.4 mm² and not more than 6.8 mm².

(7) The pneumatic radial tire for use on a passenger car according to any one of (1) to (6) above, wherein the product of a cross-sectional area of a steel cord constituting the main belt and a thread count per 50 mm unit width is not less than 4.4 mm² and not more than 6.1 mm², and a strength is 3200 Pa or greater.

(8) The pneumatic radial tire for use on a passenger car according to any one of (1) to (7) above, wherein the product of a cross-sectional area of a steel cord constituting the main belt and a thread count per 50 mm unit width is not less than 4.4 mm² and not more than 5.5 mm², and a strength is 3500 Pa or greater.

With the present technology according to claim 1, a pneumatic radial tire for use on a passenger car is realized that can retain a high degree of durability of a tire improving fuel efficiency and demonstrating an excellent effect in reducing environmental impact even when reducing belt cords to achieve reduced rolling resistance.

With the present technology according to any one of claims 2 to 8, a pneumatic radial tire for use on a passenger car is realized that has the effects obtained by the technology according to the above claim 1 more clearly and to a higher degree.

### BRIEF DESCRIPTION OF THE DRAWINGS

FIG. 1 is a tire meridian direction cross-sectional view illustrating an embodiment of a pneumatic radial tire for use on a passenger car of the present technology.

FIG. 2 is a tire meridian direction cross-sectional view illustrating another embodiment of the pneumatic radial tire for use on a passenger car of the present technology.

FIG. 3A is an explanatory view schematically illustrating a positional relationship between a belt layer and a belt auxiliary layer in the pneumatic radial tire for use on a passenger car depicted in FIG. 1, and FIG. 3B is an explanatory view schematically illustrating a positional relationship between a belt layer and a belt auxiliary layer in the pneumatic radial tire for use on a passenger car depicted in FIG. 2.

FIG. 4 is a schematic cross-sectional view describing cord arrangement in a main belt layer in the pneumatic radial tire for use on a passenger car of the present technology

### DETAILED DESCRIPTION

The pneumatic radial tire for use on a passenger car according to the present technology will be described in more detail hereinafter with reference to drawings.

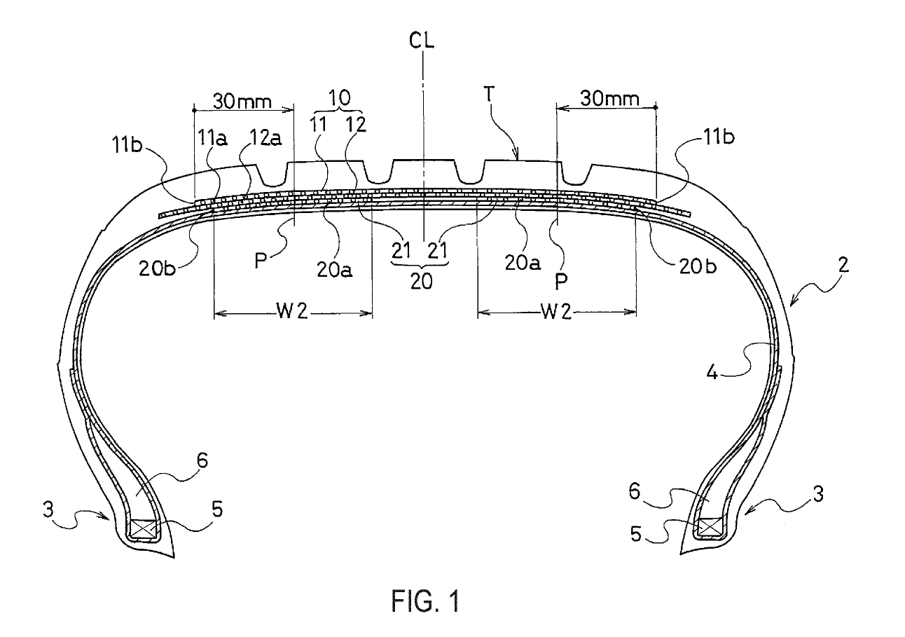

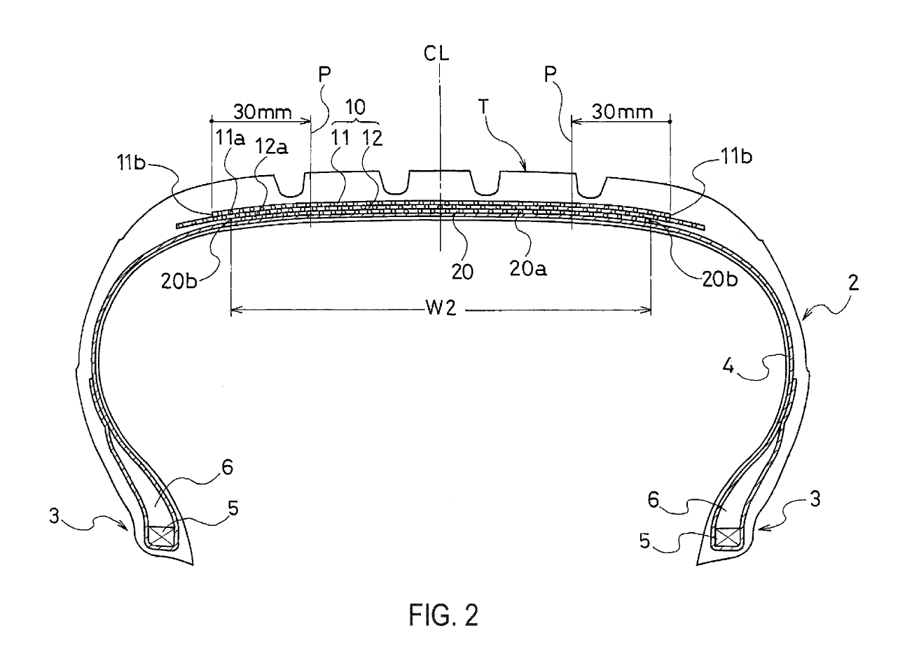

FIG. 1 and FIG. 2 both illustrate a pneumatic radial tire for use on a passenger car of the present technology, and in FIG. 1 and FIG. 2, 1 is a tread portion, 2 is a side wall portion, 3 is a bead portion, and CL is the tire equator. A single layer of a carcass layer 4 is mounted between a pair of left and right bead portions 3, 3, and an end portion of the carcass layer 4 is folded back around bead cores 5 from a tire inner side to a tire outer side. A bead filler 6 having a triangular cross-sectional shape formed from rubber is disposed on an outer circumferential side of the bead cores 5. Two main belt layers 10 (11, 12) are disposed around the entire circumference of the tire outward in a tire radial direction of the carcass layer 4 of a crown region. These main belt layers 10 (11, 12) are formed by embedding belt cords 11a, 12a formed from steel cords in the rubber. The belt cords 11a, 12a incline at low angles with respect to the tire circumferential direction, and in the present technology, the main belt 10 is configured by overlapping belt plies having steel cords embedded at an angle of 15° to 45° with respect to the tire circumferential direction in two layers in mutually crossing directions.

In the present technology, particularly, as a belt auxiliary layer 20, plies with steel cords embedded at angles from 80° to 90° with respect to the tire circumferential direction are disposed between the carcass layer 4 and the inner side main belt layer 12 so that a portion of the plies is in a position P separated 30 mm to the tire equator CL side, respectively, from both ends 11b in a width direction of the narrow width main belt layer 11, and the belt auxiliary layer 20 has a width W2 of not less than 30 mm and an initial stiffness value of not more than an initial stiffness value of the main belt layers 10 (11, 12).

Disparities between that illustrated in FIG. 1 and that illustrated in FIG. 2 are that in contrast to that illustrated in FIG. 1 where the belt auxiliary layer 20 is formed in a split type as divided pieces 21, 21 divided in the tire width direction interposing the tire equator CL, that illustrated in FIG. 2 is configured as a single ply belt auxiliary layer 20 which straddles the tire equator CL in the width direction. The width W2 of the belt auxiliary layer described above, as illustrated respectively in FIG. 1 and FIG. 2, refers to the width of each divided piece 21 in the split type while referring to the entire width thereof in the single ply.

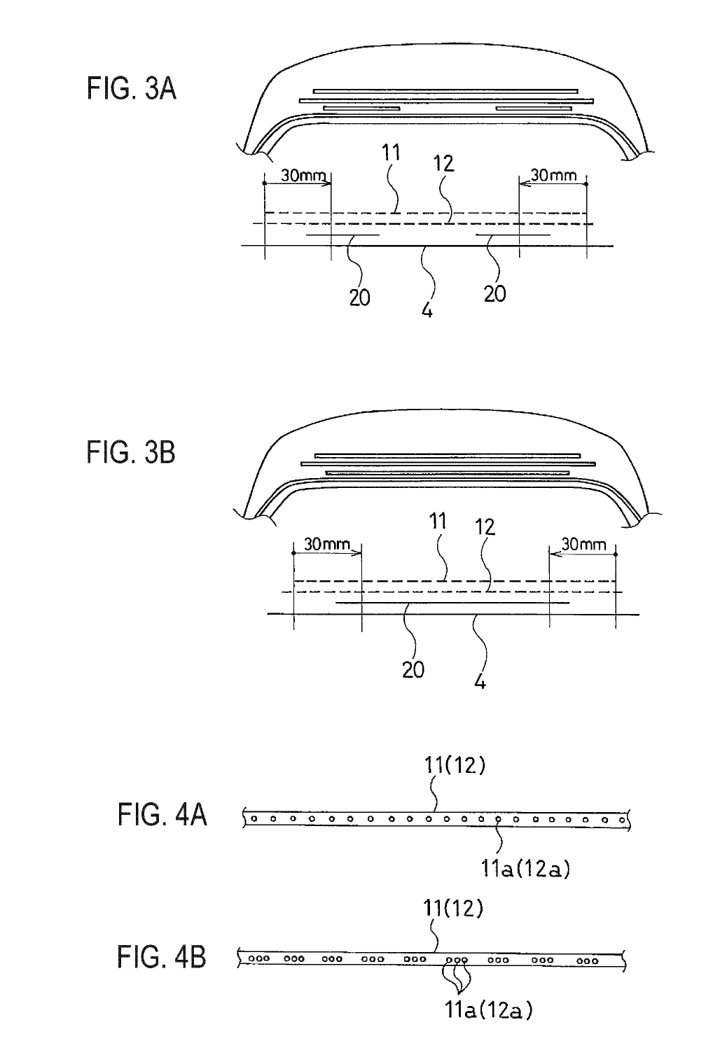

FIG. 3A is an explanatory view schematically illustrating a positional relationship between a belt layer and a belt auxiliary layer (split type) in the pneumatic radial tire for use on a passenger car illustrated in FIG. 1, and FIG. 3B is an explanatory view schematically illustrating a positional relationship between a belt layer and a belt auxiliary layer (single ply type) in the pneumatic radial tire for use on a passenger car illustrated in FIG. 2. Note that, in both FIG. 3A and FIG. 3B, two drawings are depicted one above the other, but these two drawings may not dimensionally correspond to each other in the drawing, and are depicted as so merely to facilitate understanding of the structure.

In the present technology, by satisfying the following three requirements:

(a) as a belt auxiliary layer 20, plies with steel cords embedded at angles from 80° to 90° with respect to the tire circumferential direction are disposed between the carcass layer 4 and the inner side main belt layer 12 so that a portion of the plies is in a position P separated 30 mm to the respective tire equator CL side from both ends 11b in the width direction of the narrow width main belt layer 11;

(b) as the belt auxiliary layer 20, the width W2 thereof is configured to be not less than 30 mm; and

(c) an initial stiffness value of the belt auxiliary layer 20 used is not more than an initial stiffness value of the main belt layers 10 (11, 12); it is possible to, without degrading rolling resistance, obtain a remarkable preventive effect against the occurrence of belt breakage. Particularly, the requirement (c) contributes to the former, and the requirement (a) and the requirement (b) contribute to the latter.

The initial stiffness value X of the belt auxiliary layer and the initial stiffness value Y of the main belt layer are values defined, respectively, in the following equation.

Initial stiffness value X of the belt auxiliary layer=Ex×Sx×Nx

Where,
Ex: Initial elastic modulus of the belt auxiliary layer cords (calculated from elongation when a load of 5 N to 50 N is applied)
Sx: Sum of the wire cross-sectional areas of the belt auxiliary layer cords
Nx: Auxiliary layer thread count per 50 mm unit width

Initial stiffness value Y of the main belt layer=Ey×Sy×Ny

Where,
Ey: Initial elastic modulus of the main belt cord (calculated from elongation when a load of 5 N to 50 N is applied)
Sy: Sum of the wire cross-sectional areas of the main belt cord
Ny: Main belt thread count per main 50 mm unit width

Note that when the main belt layer has two layers, the initial stiffness value Y for each main belt layer is found and an average value is taken.

When the initial stiffness value of the belt auxiliary layer 20 is greater than the initial stiffness value of the main belt layers 10 (11, 12), this is not favorable because there is a negative effect on rolling resistance, causing the restraint of the main belt layer during ground contact to be too strong, making deformation of the end portion of the main belt layer to be too great, and thus, degrading belt edge separation resistance.

The initial stiffness value of the belt auxiliary layer is preferably not less than 0.5 times and not more than 0.97 times the initial stiffness value of the main belt layer. When the initial stiffness value of the belt auxiliary layer is too great, there is a negative effect on rolling resistance which is not favorable. Meanwhile, when the initial stiffness value of the belt auxiliary layer is too low, although normally assumed to be within sufficient practical levels, the belt breakage resistance characteristics as an aspect of the present technology are lowered, and thus the effects obtained by the present technology are lessened.

Further, the steel cords 11a and 12a constituting the main belt layers 11, 12 are preferably made of a steel monofilament. With a steel monofilament, although reforming of the spiral shape or flat wave-like shape can be implemented, use of a straight monofilament where various wave reforming has not been implemented is preferred. Use of a straight monofilament allows the main belt layer to be thinner enabling a greater reducing effect of rolling resistance. A schematic cross-sectional view of the main belt layer for this case is illustrated in FIG. 4A.

The steel cords 11a, 12a constituting the main belt layers 11, 12 are preferably formed by disposing a set of two to five strands of steel monofilament as a bundle into the belt layer in bundled units. Disposing in the belt layer as bundled wire in this manner increases the wire spacing (spacing between bundles) within the belt layer, relaxes the shear strain of the rubber in the layers during contact deformation, and is therefore preferable from the perspective of reducing rolling resistance. FIG. 4B illustrates a schematic cross-sectional view of the main belt layer configured of cords having three strands of steel monofilament bundled in one unit in this case.

Further, it is preferable to use two or more steel wires twisted into steel cords as the steel cords constituting the belt auxiliary layer. Using stranded wires having excellent dampening properties for friction between strands between the main belt layer and the carcass layer improves upon weaknesses in the use of a monofilament belt that generally tends to degrade riding comfort because it is not good at dampening by stiffness. Thus, a preferable thread count is from 15 to 35 strands per 50 mm unit width.

As illustrated in FIGS. 1 and 2, the belt auxiliary layer is formed by embedding belt auxiliary cords 20a that are formed from steel cords into the rubber. These belt auxiliary cords 20a are inclined at a high angle with respect to the tire circumferential direction, and the inclination angle is from 80° to 90° and preferably from 87° to 90°. In other words, it is disposed in the radial direction, and by providing the belt auxiliary layer 20 in this manner, buckling of the main belt layer cords 11a, 12a can be suppressed and fatigue resistance with respect to flexing that decreases can be supplemented even when a monofilament is used as the main belt layer cord. As a result, both a reduction in the rolling resistance and an improvement in tire durability can be achieved.

Further, it is preferred that the product of a cross-sectional area of the steel cord constituting the main belt layer and a thread count per 50 mm unit width is not less than 4.4 mm² and not more than 6.8 mm².

Alternatively, it is preferred that the product of a cross-sectional area of the steel cord constituting the main belt layer 10 and a thread count per 50 mm unit width is not less than 4.4 mm² and not more than 6.1 mm², and that a strength of this steel cord is not less than 3200 Pa.

Regardless of the range of the strength, if the product of the cross-sectional area of the steel monofilament constituting the main belt layer 10 and the thread count per 50 mm unit width is less than 4.4 mm², the abundance of the main belt layer cords 10a will be excessively low, rigidity will be insufficient, and durability will decline, which is not favorable. In cases where the strength is 3200 Pa or greater and the product of the cross-sectional area and the thread count is greater than 6.1 mm², or the strength is 3500 MPa or greater and the product of the cross-sectional area and the thread count is greater than 5.5 mm², the abundance of the main belt layer cords 10a will exceed the amount needed to sufficiently maintain the durability within each strength range. As a result, the amount of cord will be excessive, which will lead to an increase in mass, and the cord pitch will be narrowed, which will lead to insufficient adhesion. Thus, the durability of the tire will decline, which is not favorable. Further, this may inhibit reduction of rolling resistance due to an increase in energy loss in the belt rubber, and is not favorable.

### Examples

19 types of test tires were fabricated for Conventional Examples 1 and 2, Comparative Examples 1 to 3, and Working Examples 1 to 14. Each of these test tires was a pneumatic tire with a tire size of 195/65R15. For the main belt layers, the type of belt cord and the initial stiffness were each modified as shown in Tables 1 to 3. For the belt auxiliary layer, presence/absence and arrangement of the belt auxiliary layer; structure and angle of the belt auxiliary cords; arrangement form, layer width, and presence/absence of overlap with the position P of the belt auxiliary layer; and thread count of the belt reinforcing cords were each modified as shown in Tables 1 to 3.

Belt breakage durability (normal conditions), belt breakage durability (severe conditions), belt-edge-separation durability, and rolling resistance were evaluated according to the methods described below and recorded in Tables 1 to 3 for each of the 19 types of test tires.

In Conventional Example 1, a normal main belt layer was used without disposing a belt auxiliary layer thus representing a commonly used conventional structure. In Conventional Example 2, a main belt layer having a reduced wire amount compared to Conventional Example 1 was used, and although improvement in rolling resistance was evident, degradation in belt breakage durability did not reach a passing level.

In Comparative Example 1, worsening of separation resistance was demonstrated as usage amounts of the belt auxiliary layer increased even with cords having the same stiffness and strength as the main belt layer.

When comparing Working Examples 1 and 2, it can be seen that less stiffness in the auxiliary layer has less negative effect on rolling resistance and is therefore more preferred. As can be seen from Working Example 4, when the stiffness of the belt auxiliary layer is low, there is no problem in practical use, but durability deteriorates when compared in belt breakage durability testing (severe conditions).

As can be seen from Comparative Example 2, when the belt auxiliary layer is too close to the inner side, belt durability is poor, but this is because buckling deformation of the main belt layer occurs more easily when this slip angle is larger, thus lowering belt breakage durability. As can be seen from Comparative Example 3, when the width of the belt auxiliary layer is too narrow, a sufficient reinforcing effect cannot be obtained, and therefore, belt durability worsens similar to that in Comparative Example 2.

As can be seen from Working Example 7, when there is a large thread count (strands) of the main belt layer cords, the cord spacing becomes narrower which increases the energy loss in the belt rubber leading to an adverse effect on rolling resistance. Meanwhile, as can be seen from Working Example 11, when there is a low thread count (strands) of the main belt layer cords, the stiffness of the main belt layer is reduced leading to deterioration in belt breakage durability.

As can be seen from Working Example 12, when the main belt layer cords are configured of a single monofilament wire, the belt gauge becomes thinner which reduces rolling resistance. Furthermore, as can be seen from Working Example 13, aligning two monofilament wires as a single bundled unit for the main belt layer cord relaxes the shear strain between the wires thus reducing rolling resistance.

### (1) Belt Breakage Durability (Normal Conditions)

A drum test machine having a smooth, steel drum surface and a diameter of 1,707 mm was used, and ambient temperature was controlled to 38±3° C. The test tires were assembled on a rim having a rim size of 15×6 J, and inflated to an internal test pressure of 160 kPa. Then, the test tires were run for 10 hours and 300 km under the following conditions while varying the load and slip angle using a 0.083 Hz square waveform: Running speed: 30 km/hr, Slip angle: 0±4°, Load: 70%±40% variable of the maximum load designated by JATMA (Japan Automobile Tyre Manufacturers Association). After the running, the tires were cut open and the belt cords were examined for the presence/absence of failures. Results were evaluated using a two-choice system in which examples where belt cord failure occurred were indicated with an “X (Fail)” and examples where belt cord failure did not occur were indicated with an “O (Pass)”.

### (2) Belt Breakage Durability (Severe Conditions)

A drum test machine having a smooth, steel drum surface and a diameter of 1,707 mm was used, and ambient temperature was controlled to 38±3° C. The test tires were assembled on a rim having a rim size of 15×6 J, and inflated to an internal test pressure of 160 kPa. Then, the test tires were run for 10 hours and 300 km under the following conditions while varying the load and slip angle using a 0.083 Hz square waveform: Running speed: 30 km/hr, Slip angle: 0±5°, Load: 70%±40% variable of the maximum load designated in the JATMA Year Book 2009. After the running, the tires were cut open and the belt cords were examined for the presence/absence of failures. Results were evaluated using a two-choice system in which examples where belt cord failure occurred were indicated with an “X (Fail)” and examples where belt cord failure did not occur were indicated with an “O (Pass)”.

### (3) Belt-Edge-Separation Durability

The test tires were assembled on a rim having a rim size of 15×6 J and inflated with oxygen to an internal pressure of 240 kPa and stored for two weeks in a chamber having a room temperature maintained at 60° C. Then, the oxygen inside was released and the tires were filled with air to 160 kPa. A drum test machine having a smooth, steel drum surface and a diameter of 1,707 mm was used, and ambient temperature was controlled to 38±3° C. The test tires pretreated as described above were run for 100 hours and 5,000 km under the following conditions while varying the load and slip angle using a 0.083 Hz square waveform: Running speed: 50 km/hr, Slip angle: 0±3°, Load: 70%±40% variable of the maximum load designated in the JATMA Year Book 2009. After the running, the tires were cut open and confirmation of the presence/absence of a separated portion having a separation length in the width direction of 5 mm or greater in the end portion in the width direction of the belt was conducted. The absence of belt separation indicates that belt-edge-separation durability is superior.

Results were evaluated using a two-choice system in which examples where a separated portion with a length of 5 mm or greater was present were indicated with an “X (Fail)” and examples where a separated portion with a length of 5 mm or greater was absent were indicated with an “0 (Pass)”.

### (4) Rolling Resistance

Using a drum test machine having a smooth, steel drum surface and a diameter of 1,707 mm, the test tires, being assembled on rims having a rim size of 15×6 J and inflated to an internal pressure of 200 kPa, were loaded with a load equivalent to 85% of the maximum load at the air pressure as designated in the JATMA Year Book 2009 and pressed against the drum. In this state, the rolling resistance of the test tires was measured at a running speed of 80 km/hr.

Measurement results were expressed as an index with the measured value for Conventional Example 1 being 100. Higher index values indicate the rolling resistance is low and excellent.

TABLE 1

| | Conventional | Conventional | Comparative |
|---|---|---|---|
| | Example 1 | Example 2 | Example 1 |
| Main belt layer cord structure | 2 + 2 × 0.25 | 2 + 2 × 0.25 | 2 + 2 × 0.25 |
| Main belt layer wire strength (MPa) | 3100 | 3100 | 3100 |
| Main belt layer thread count | 36 | 30 | 30 |
| (strands/50 mm) | | | |
| Main belt layer wire amount | 7.07 | 5.89 | 5.89 |
| (mm²/50 mm unit width) | | | |
| Main belt layer initial stiffness | 1060 | 883 | 883 |
| (kN/50 mm unit width) | | | |
| Belt auxiliary layer cord structure | — | — | 2 + 2 × 0.25 |
| Auxiliary layer thread count | — | — | 33 |
| (strands/50 mm) | | | |
| Auxiliary layer wire amount | — | — | 6.48 |
| (mm²/50 mm unit width) | | | |
| Auxiliary layer initial stiffness | — | — | 971 |
| (kN/50 mm unit width) | | | |
| Stiffness comparison (auxiliary/ | — | — | 1.10 |
| main belt) | | | |
| Belt auxiliary layer arrangement | — | — | 2 ply split |
| Belt auxiliary layer width (mm) | — | — | 40 |
| Belt auxiliary layer outer side | — | — | 20 |
| position (separation distance | | | |
| (mm) from 11B) | | | |
| Belt breakage durability (normal | ∘ | x | ∘ |
| conditions) | | | |
| Belt breakage durability (severe | ∘ | x | ∘ |
| conditions) | | | |
| Belt edge separation durability | ∘ | ∘ | x |
| Rolling resistance | 100 | 102 | 101 |

| | Working | Working | Working | Working |
|---|---|---|---|---|
| | Example 1 | Example 2 | Example 3 | Example 4 |
| Main belt layer cord structure | 2 + 2 × 0.25 | 2 + 2 × 0.25 | 2 + 2 × 0.25 | 2 + 2 × 0.25 |
| Main belt layer wire strength (MPa) | 3100 | 3100 | 3100 | 3100 |
| Main belt layer thread count | 30 | 30 | 30 | 30 |
| (strands/50 mm) | | | | |
| Main belt layer wire amount | 5.89 | 5.89 | 5.89 | 5.89 |
| (mm²/50 mm unit width) | | | | |
| Main belt layer initial stiffness | 883 | 883 | 883 | 883 |
| (kN/50 mm unit width) | | | | |
| Belt auxiliary layer cord structure | 2 + 2 × 0.25 | 2 + 2 × 0.25 | 2 + 2 × 0.25 | 2 + 2 × 0.25 |
| Auxiliary layer thread count | 30 | 29 | 15 | 14 |
| (strands/50 mm) | | | | |
| Auxiliary layer wire amount | 5.89 | 5.69 | 2.94 | 2.75 |
| (mm²/50 mm unit width) | | | | |
| Auxiliary layer initial stiffness | 883 | 854 | 442 | 412 |
| (kN/50 mm unit width) | | | | |
| Stiffness comparison (auxiliary/ | 1.00 | 0.97 | 0.50 | 0.47 |
| main belt) | | | | |
| Belt auxiliary layer arrangement | 2 ply | 2 ply | 2 ply | 2 ply |
| | split | split | split | split |
| Belt auxiliary layer width (mm) | 40 | 40 | 40 | 40 |
| Belt auxiliary layer outer side | 20 | 20 | 20 | 20 |
| position (separation distance | | | | |
| (mm) from 11B) | | | | |
| Belt breakage durability (normal | ∘ | ∘ | ∘ | ∘ |
| conditions) | | | | |
| Belt breakage durability (severe | ∘ | ∘ | ∘ | x |
| conditions) | | | | |
| Belt edge separation durability | ∘ | ∘ | ∘ | ∘ |
| Rolling resistance | 101 | 102 | 102 | 102 |

TABLE 2

| | Comparative | Comparative | Working | Working |
|---|---|---|---|---|
| | Example 2 | Example 3 | Example 5 | Example 6 |
| Main belt layer cord structure | 2 + 2 × 0.25 | 2 + 2 × 0.25 | 2 + 2 × 0.25 | 2 + 2 × 0.25 |
| Main belt layer wire strength | | | | |
| (MPa) | | | | |
| Main belt layer thread count | 30 | 30 | 30 | 30 |
| (strands/50 mm) | | | | |
| Main belt layer wire amount | 5.89 | 5.89 | 5.89 | 5.89 |
| (mm²/50 mm unit width) | | | | |
| Main belt layer initial stiffness | 883 | 883 | 883 | 883 |
| (kN/50 mm unit width) | | | | |
| Belt auxiliary layer cord | 2 + 2 × 0.25 | 2 + 2 × 0.25 | 2 + 2 × 0.25 | 2 + 2 × 0.25 |
| structure | | | | |
| Auxiliary layer thread count | 29 | 29 | 29 | 29 |
| (strands/50 mm) | | | | |
| Auxiliary layer wire amount | 5.69 | 5.69 | 5.69 | 5.69 |
| (mm²/50 mm unit width) | | | | |
| Auxiliary layer initial stiffness | 854 | 854 | 854 | 854 |
| (kN/50 mm unit width) | | | | |
| Stiffness comparison (auxiliary/ | 0.97 | 0.97 | 0.97 | 0.97 |
| main belt) | | | | |
| Belt auxiliary layer arrangement | 2 ply | 2 ply | 2 ply | 2 ply |
| | split | split | split | split |
| Belt auxiliary layer width (mm) | 40 | 25 | 40 | 30 |
| Belt auxiliary layer outer side | 35 | 15 | 30 | 15 |
| position (separation distance | | | | |
| (mm) from 11B) | | | | |
| Belt breakage durability | x | x | ∘ | ∘ |
| (normal conditions) | | | | |
| Belt breakage durability (severe | x | x | ∘ | ∘ |
| conditions) | | | | |
| Belt edge separation durability | ∘ | ∘ | ∘ | ∘ |
| Rolling resistance | 102 | 102 | 102 | 102 |

| | Working | Working | Working |
|---|---|---|---|
| | Example 7 | Example 8 | Example 9 |
| Main belt layer cord structure | 2 + 2 × 0.25 | 2 + 2 × 0.25 | 2 + 2 × 0.25 |
| Main belt layer wire strength (MPa) | 3100 | 3100 | 3100 |
| Main belt layer thread count | 35 | 32 | 30 |
| (strands/50 mm) | | | |
| Main belt layer wire amount | 5.89 | 6.28 | 5.89 |
| (mm²/50 mm unit width) | | | |
| Main belt layer initial stiffness | 883 | 942 | 883 |
| (kN/50 mm unit width) | | | |
| Belt auxiliary layer cord structure | 2 + 2 × 0.25 | 2 + 2 × 0.25 | 2 + 2 × 0.25 |
| Auxiliary layer thread count | 25 | 25 | 25 |
| (strands/50 mm) | | | |
| Auxiliary layer wire amount | 4.91 | 4.91 | 4.91 |
| (mm²/50 mm unit width) | | | |
| Auxiliary layer initial stiffness | 736 | 736 | 736 |
| (kN/50 mm unit width) | | | |
| Stiffness comparison (auxiliary/ | 0.83 | 0.78 | 0.83 |
| main belt) | | | |
| Belt auxiliary layer arrangement | 2 ply | 2 ply | 2 ply |
| | split | split | split |
| Belt auxiliary layer width (mm) | 40 | 40 | 40 |
| Belt auxiliary layer outer side | 15 | 15 | 15 |
| position (separation distance | | | |
| (mm) from 11B) | | | |
| Belt breakage durability (normal | ∘ | ∘ | ∘ |
| conditions) | | | |
| Belt breakage durability (severe | ∘ | ∘ | ∘ |
| conditions) | | | |
| Belt edge separation durability | ∘ | ∘ | ∘ |
| Rolling resistance | 101 | 102 | 102 |

TABLE 3

| | Working | Working | Working | Working |
|---|---|---|---|---|
| | Example 10 | Example 11 | Example 12 | Example 13 |
| Main belt layer cord structure | 2 + 2 × 0.25 | 2 + 2 × 0.25 | φ0.35, 1 | φ0.35, 1 |
| | | | strand | strand |
| Main belt layer wire strength | 3100 | 3100 | 3100 | 3100 |
| (MPa) | | | | |
| Main belt layer tread count | 26 | 25 | 60 | 30 × 2 |
| (strands/50 mm) | | | | |
| Main belt layer wire amount | 5.10 | 4.91 | 5.77 | 5.77 |
| (mm²/50 mm unit width) | | | | |
| Main belt layer initial stiffness | 765 | 736 | 1183 | 1183 |
| (kN/50 mm unit width) | | | | |
| Belt auxiliary layer cord | 2 + 2 × 0.25 | 2 + 2 × 0.25 | 2 + 2 × 0.25 | 2 + 2 × 0.25 |
| structure | | | | |
| Auxiliary layer thread count | 25 | 25 | 25 | 25 |
| (strands/50 mm) | | | | |
| Auxiliary layer wire amount | 4.91 | 4.91 | 4.91 | 4.91 |
| (mm²/50 mm unit width) | | | | |
| Auxiliary layer initial stiffness | 736 | 736 | 736 | 736 |
| (kN/50 mm unit width) | | | | |
| Stiffness comparison | 0.96 | 1.00 | 0.62 | 0.62 |
| (auxiliary/main belt) | | | | |
| Belt auxiliary layer arrangement | 2 ply | 2 ply | 2 ply | 2 ply |
| | split | split | split | split |
| Belt auxiliary layer width (mm) | 40 | 40 | 40 | 40 |
| Belt auxiliary layer outer side | 15 | 15 | 15 | 15 |
| position (separation distance | | | | |
| (mm) from 11B) | | | | |
| Belt breakage durability (normal | ∘ | ∘ | ∘ | ∘ |
| conditions) | | | | |
| Belt breakage durability (severe | ∘ | x | ∘ | ∘ |
| conditions) | | | | |
| Belt edge separation durability | ∘ | ∘ | ∘ | ∘ |
| Rolling resistance | 102 | 102 | 103 | 104 |

1. A pneumatic radial tire for use on a passenger car, comprising:
a main belt layer in which belt plies with steel cords embedded at an angle of 15° to 45° with respect to a tire circumferential direction are overlapped in two layers in mutually crossing directions on an outer side in a tire radial direction of a carcass layer of a crown region;
as a belt auxiliary layer, plies with steel cords embedded at an angle of 80° to 90° with respect to the tire circumferential direction being disposed between a carcass layer and an inner side main belt layer so that a portion of the plies is in a position separated 30 mm to a tire equator side, respectively from both ends in a width direction of a narrow width main belt layer; and
the belt auxiliary layer having a width of not less than 30 mm and an initial stiffness value of the belt auxiliary layer being not more than an initial stiffness value of the main belt layer.

2. The pneumatic radial tire for use on a passenger car according to claim 1, wherein the belt auxiliary layer has an initial stiffness value of not less than 0.5 times and not more than 0.97 times an initial stiffness value of the main belt layer.

3. The pneumatic radial tire for use on a passenger car according to claim 1, wherein the steel cord constituting the main belt layer is a steel monofilament.

4. The pneumatic radial tire for use on a passenger car according to claim 3, wherein the steel cord constituting the main belt is disposed in a belt layer as a bundled wire formed from a set of two to five steel monofilaments.

5. The pneumatic radial tire for use on a passenger car according to claim 1, wherein the steel cord constituting the belt auxiliary layer is a steel cord in which two or more steel wires are twisted together.

6. The pneumatic radial tire for use on a passenger car according to claim 1, wherein a product of a cross-sectional area of a steel cord constituting the main belt and a thread count per 50 mm unit width is not less than 4.4 mm² and not more than 6.8 mm².

7. The pneumatic radial tire for use on a passenger car according to claim 1, wherein a product of a cross-sectional area of a steel cord constituting the main belt and a thread count per 50 mm unit width is not less than 4.4 mm² and not more than 6.1 mm², and a strength is 3200 Pa or greater.

8. The pneumatic radial tire for use on a passenger car according to claim 1, wherein a product of a cross-sectional area of a steel cord constituting the main belt and a thread count per 50 mm unit width is not less than 4.4 mm² and not more than 5.5 mm², and a strength is 3500 Pa or greater.

9. The pneumatic radial tire for use on a passenger car according to claim 2, wherein the steel cord constituting the main belt layer is a steel monofilament.

10. The pneumatic radial tire for use on a passenger car according to claim 9, wherein the steel cord constituting the main belt is disposed in a belt layer as a bundled wire formed from a set of two to five steel monofilaments.

11. The pneumatic radial tire for use on a passenger car according to claim 2, wherein the steel cord constituting the belt auxiliary reinforcing layer is a steel cord in which two or more steel wires are twisted together.

12. The pneumatic radial tire for use on a passenger car according to claim 2, wherein a product of a cross-sectional area of a steel cord constituting the main belt and a thread count per 50 mm unit width is not less than 4.4 mm² and not more than 6.8 mm².

13. The pneumatic radial tire for use on a passenger car according to claim 3, wherein a product of a cross-sectional area of a steel cord constituting the main belt and a thread count per 50 mm unit width is not less than 4.4 mm² and not more than 6.8 mm².

14. The pneumatic radial tire for use on a passenger car according to claim 4, wherein a product of a cross-sectional area of a steel cord constituting the main belt and a thread count per 50 mm unit width is not less than 4.4 mm² and not more than 6.8 mm².

15. The pneumatic radial tire for use on a passenger car according to claim 2, wherein a product of a cross-sectional area of a steel cord constituting the main belt and a thread count per 50 mm unit width is not less than 4.4 mm² and not more than 6.1 mm², and a strength is 3200 Pa or greater.

16. The pneumatic radial tire for use on a passenger car according to claim 3, wherein a product of a cross-sectional area of a steel cord constituting the main belt and a thread count per 50 mm unit width is not less than 4.4 mm² and not more than 6.1 mm², and a strength is 3200 Pa or greater.

17. The pneumatic radial tire for use on a passenger car according to claim 4, wherein a product of a cross-sectional area of a steel cord constituting the main belt and a thread count per 50 mm unit width is not less than 4.4 mm² and not more than 6.1 mm², and a strength is 3200 Pa or greater.

18. The pneumatic radial tire for use on a passenger car according to claim 2, wherein a product of a cross-sectional area of a steel cord constituting the main belt and a thread count per 50 mm unit width is not less than 4.4 mm² and not more than 5.5 mm², and a strength is 3500 Pa or greater.

19. The pneumatic radial tire for use on a passenger car according to claim 3, wherein a product of a cross-sectional area of a steel cord constituting the main belt and a thread count per 50 mm unit width is not less than 4.4 mm² and not more than 5.5 mm², and a strength is 3500 Pa or greater.

20. The pneumatic radial tire for use on a passenger car according to claim 4, wherein a product of a cross-sectional area of a steel cord constituting the main belt and a thread count per 50 mm unit width is not less than 4.4 mm² and not more than 5.5 mm², and a strength is 3500 Pa or greater.
